(19) United States
(12) Patent Application Publication
(10) Pub. No.: US 2026/0074417 A1
(43) Pub. Date: Mar. 12, 2026

(54) VEHICLE ROOF STRUCTURE AND CONDUCTOR PLATE

(71) Applicant: TOYOTA JIDOSHA KABUSHIKI KAISHA, Toyota-shi (JP)

(72) Inventors: Takuma SAWAYA, Nagoya-shi (JP); Katsumasa AOKI, Toyota-shi (JP)

(73) Assignee: TOYOTA JIDOSHA KABUSHIKI KAISHA, Toyota-shi (JP)

(21) Appl. No.: 19/280,693

(22) Filed: Jul. 25, 2025

(30) Foreign Application Priority Data
Sep. 6, 2024 (JP) 2024-153774

(51) Int. Cl. H01Q 1/32; B60R 13/02; B62D 25/06

(52) U.S. Cl. CPC H01Q 1/3275; B60R 13/0212; B62D 25/06; H01Q 1/3233

(57) ABSTRACT

In a vehicle roof structure forming a space in which a communication module having a first antenna and a base substrate and a second antenna are arranged between a roof panel and a roof lining, a roof panel cover of a non-conductor is arranged above the space, a conductor plate capable of attaching the communication module and the second antenna is arranged below the space, and an opening is provided in at least a part of a portion of the conductor plate facing the base substrate.

### CROSS-REFERENCE TO RELATED APPLICATION

This application claims priority to Japanese Patent Application No. 2024-153774 filed on Sep. 6, 2024. The disclosure of the above-identified application, including the specification, drawings, and claims, is incorporated by reference herein in its entirety.

### BACKGROUND

### 1. Technical Field

The present disclosure relates to wireless communication.

### 2. Description of Related Art

A system in which a computer mounted on a vehicle performs wireless communication is becoming popular. In this regard, Japanese Unexamined Patent Application Publication No. 2022-157613 (JP 2022-157613 A), for example, discloses a technique related to the arrangement position of a communication antenna mounted on a vehicle.

### SUMMARY

An object of the present disclosure is to improve the transmission efficiency of a wireless signal.

An aspect of the present disclosure provides
a vehicle roof structure, in which a space in which a communication module having a first antenna and a base substrate and a second antenna are disposed is formed between a roof panel and a roof lining, in which:
a roof panel cover of a non-conductive material is disposed above the space; a conductor plate to which the communication module and the second antenna are attachable is disposed below the space; and an opening is provided in at least a part of a portion of the conductor plate facing the base substrate.

An aspect of the present disclosure provides a conductor plate disposed between a roof panel and a roof lining of a vehicle, a communication module having a first antenna and a base substrate and a second antenna being attachable to the conductor plate, in which an opening is provided in at least a part of a portion of the conductor plate facing the base substrate.

According to the present disclosure, it is possible to improve the transmission efficiency of a wireless signal.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating an example of a configuration of a vehicle system according to an embodiment;

FIG. 2 is a schematic diagram illustrating an exemplary configuration of DCM 10 and the in-vehicle device 20;

FIG. 3 is a diagram schematically illustrating an exemplary functional configuration of a DCM 10;

FIG. 4 is a hardware-appearance view of a DCM 10;

FIG. 5 is a perspective view illustrating the arrangement of DCM 10;

FIG. 6 is a cross-sectional view illustrating the arrangement of DCM 10; and

FIG. 7 is a cross-sectional view illustrating the arrangement of a conventional DCM.

### DETAILED DESCRIPTION OF EMBODIMENTS

Vehicles equipped with communication terminals are increasing. Further, in recent years, with the improvement of the vehicle function, the amount of communication data tends to increase, and it is required to maximize the efficiency of communication.

In a communication module using radio waves in a high frequency band having high straightness, an antenna is often arranged above a vehicle (for example, near a roof) in order to secure a ground height.

A roof structure according to an embodiment of the present disclosure forms a space in which a communication module having a first antenna and a base substrate and a second antenna are disposed between a roof panel and a roof lining.

The roof panel is a member constituting the upper surface of the roof of the vehicle. Further, the roof lining is an interior member arranged on the lower surface of the roof of the vehicle.

The in-vehicle communication module inputs and outputs wireless signals via the first antenna. By providing a space between the roof panel and the roof lining and arranging the communication module and the antenna in the space, a high gain can be obtained.

The second antenna is typically an antenna other than a data communication antenna, and is, for example, a broadcast-receiving antenna, a GPS antenna, or the like.

In such a roof structure, the upper surface of the space is covered with a non-conductor (for example, a resin plate), and the other surface (side surface or bottom surface) is often covered with a conductor (for example, a metal) plate. Accordingly, the antenna can be protected from electromagnetic noise generated in the vehicle, and a decrease in gain caused by noise can be suppressed.

However, when a space provided in the roof is covered with a conductor, cavity resonance may occur due to electromagnetic waves generated inside and outside. When the resonance frequency is close to the frequency to be communicated, communication may be disturbed.

Further, when the base substrate and the conductor plate of the communication module are close to each other, a high-frequency current having a reverse phase flows between the base substrate and the conductor plate. This may act like noise, degrading the radiation performance of the first antenna.

Therefore, in the roof structure according to the present disclosure, a non-conductive roof panel cover is disposed above the space. Further, a conductor plate to which the communication module and the second antenna can be attached is disposed below the space, and an opening is provided in at least a part of a portion of the conductor plate facing the base substrate.

That is, while the space in the roof is covered with the conductor plate, an opening (a notch or the like) is provided in a portion of the conductor plate close to the base substrate.

Accordingly, it is possible to suppress the generation of the above-described reverse phase current while having a certain role of shielding the electromagnetic wave generated in the vehicle, and to improve the radiation performance of the radio wave. Further, by adjusting the size of the opening, it is possible to suppress the resonance or to control the resonance frequency.

The conductor plate may have a rising portion surrounding a side of the space. That is, the four directions of the side surface and the bottom surface may be covered by the conductor plate.

The first antenna may be an antenna for cellular communication, and the second antenna may be an antenna for broadcast reception. The second antenna may be, for example, an antenna for television reception, an antenna for radio reception, or the like. The frequency band of the broadcast is lower than the frequency band of the cellular communication and is susceptible to noise, so there is a practical benefit of shielding by the conductor plate.

The maximum length of the opening (e.g., diagonal length) may be determined based on the frequency of the noise to be suppressed.

When the size of the opening is X, the upper limit wavelength λ of the radio wave transmitted through the opening is represented by X=λ/2 according to the operation principle of the slot antenna.

For example, when the largest length of the opening portion is 200 millimeters or less, radio waves below 750 MHz can be shielded and radio waves with frequencies of 750 MHz or higher can be transmitted. In other words, resonances occurring at frequencies above 750 MHz can be reduced. The maximum length of the opening portion may be appropriately set in accordance with the frequency of noise to be suppressed, the pitch of the screw holes for fixing the communication module, and the like as described above.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### First Embodiment

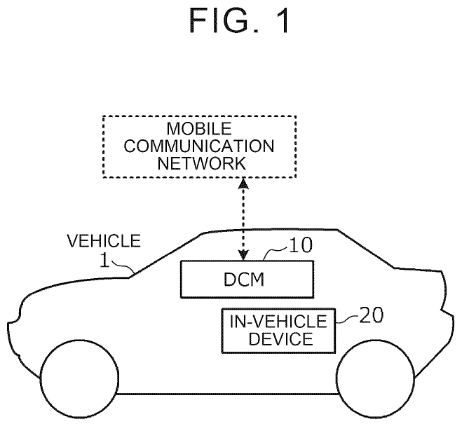

An outline of a vehicle system according to a first embodiment will be described with reference to FIG. 1. The vehicle system according to the present embodiment includes the vehicle 1.

The vehicle 1 is a connected car having a communication function with an external device. The vehicle 1 includes a DCM (Data Communication Module) 10 and an in-vehicle device 20.

The external device is a device outside the vehicle 1. The external device may be, for example, a server device connected to the Internet, or may be a terminal (mounted on another vehicle), a roadside device, or the like that is in the vicinity of the vehicle 1 and is capable of direct communication with DCM 10.

The DCM 10 is a device for performing wireless communication with another device (or an external network) via a network. DCM 10 functions as a gateway for connecting a component of the vehicle 1 (hereinafter, referred to as a vehicle component) to a network outside the vehicle or an external device.

DCM 10 may provide communication (cellular communication) toward a mobile communication network. The mobile communication network is connected to a wide area network such as the Internet, so that various components of the vehicle 1 can communicate with any external device.

The in-vehicle device 20 is mounted on the vehicle 1 and provides information to an occupant of the vehicle 1. The in-vehicle device 20 is also called a car navigation device, an infotainment device, or a head unit. The in-vehicle device 20 can provide navigation and entertainment to an occupant of the vehicle. The in-vehicle device 20 may have a function of receiving television or radio broadcasting. In addition, the in-vehicle device 20 may be a device that can cooperate with a smartphone or the like.

The amount of communication data handled by DCM installed in the vehicle is expected to increase in the future with the improvement of the vehicle function. Therefore, there is a need to improve the communication efficiency of DCM.

Therefore, in DCM 10 according to the present embodiment, both the antenna and the communication module are installed inside the roof of the vehicle 1. This ensures a line-of-sight and makes the cable connecting the antenna and the communication module as short as possible. A specific arrangement method will be described later.

Further, in the present embodiment, an antenna for broadcast reception, which is used by the in-vehicle device 20, is disposed inside the roof of the vehicle 1. That is, both the antenna for cellular communication (first antenna) and the antenna for broadcast reception (second antenna) are arranged inside the roof of the vehicle 1.

The interior of the roof is shielded by electrical conductors to improve noise resistance. As a result, reception sensitivity of television broadcasting and radio broadcasting can be improved.

On the other hand, if the inside of the roof is shielded by a conductor, cavity resonance may occur in the roof, which may hinder communication. Further, when DCM 10 base-board and the conductor are arranged close to each other, high-frequency current of the opposite phase flows, which may become noisy, and the radiation performance of the antenna may deteriorate. Therefore, in the present embodiment, the conductor disposed inside the roof has a specific shape, thereby dealing with the problem. Details will be described later.

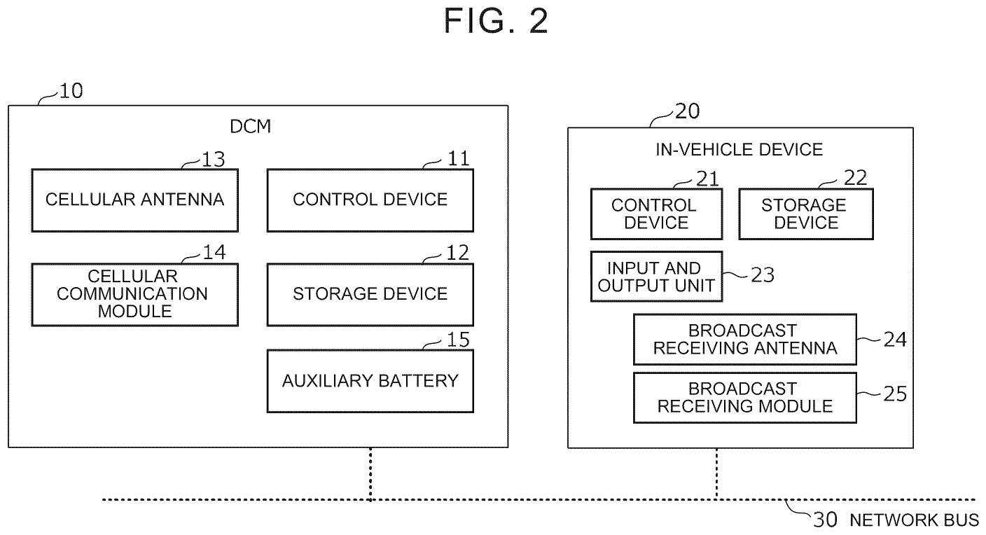

FIG. 2 is a diagram illustrating components of DCM 10 and the in-vehicle device 20 according to the present embodiment. DCM 10 according to the present embodiment includes a control device 11, a storage device 12, a cellular antenna 13, a cellular communication module 14, and an auxiliary battery 15.

The in-vehicle device 20 includes a control device 21, a storage device 22, a broadcast receiving antenna 24, and a broadcast receiving module 25.

First, DCM 10 will be described.

The control device 11 is an arithmetic unit that realizes various functions of DCM 10 by executing a predetermined program.

The control device 11 performs a function of mediating communication performed between an external device and a component (vehicle component) of the vehicle 1. The vehicle component is, for example, one or more in-vehicle devices mounted on the vehicle 1. The external device may be, for example, a server device that provides information.

For example, when a vehicle component requires communication with an external device, the control device 11 executes a function of relaying data transmitted from the vehicle component to an external device (or an external network). In addition, a function of receiving data transmitted from an external device (or an external network) and transferring the data to an appropriate vehicle component is performed.

Furthermore, the control device 11 can execute a function specific to the own device. For example, the control device 11 is configured to be capable of executing a monitoring function and a call function of a security system, and can perform a security notification, an emergency notification, or the like based on a trigger generated in the vehicle.

The storage device 12 is a memory device including a main storage device and an auxiliary storage device. The secondary storage device stores an operating system (OS), various programs, various tables, and the like. Then, by loading the program stored therein into the main storage device and executing the program, it is possible to realize each function that matches a predetermined purpose as described later.

The cellular antenna 13 is an antenna element for inputting and outputting a radio signal. In the present embodiment, the cellular antenna 13 is adapted to cellular communication (e.g., mobile communication such as 3G, LTE, 5G). The cellular antenna 13 may include a plurality of physical antennas. For example, in the case of using mobile communication via a high frequency, a plurality of antennas may be arranged in a distributed manner in order to stabilize communication.

The cellular communication module 14 is a communication module for performing mobile communication.

The secondary battery 15 is a battery that supplies backup power to DCM 10. DCM 10 operates by the power supplied from the vehicles 1, but the power supply may be cut off due to a traffic accident, an illegal act, or the like. In such cases, the secondary battery 15 supplies power to DCM 10. As a result, DCM 10 can continue the operation even in an emergency. The auxiliary battery 15 may be charged when power is supplied from the vehicle 1.

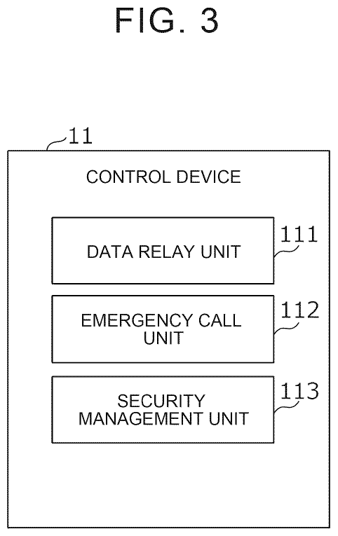

Next, the functions executed by the control device 11 will be described. FIG. 3 is a diagram illustrating functional modules included in the control device 11. The illustrated functional modules can be realized by executing a program stored in a storage unit such as a ROM by the control device 11.

A data relay unit 111 relays data transmitted and received between vehicle components. For example, a process of receiving a message sent by a first device connected to an in-vehicle network and transferring the message to a second device connected to the in-vehicle network is executed as necessary.

In addition, when receiving a message addressed to an external device from a vehicle component, the data relay unit 111 relays the message to an external network. It receives the data transmitted from the external network and transfers the data to an appropriate vehicle component.

When an abnormal situation occurs in the vehicle 1, the emergency notification unit 112 makes an emergency notification to an operator outside the vehicle. An example of an abnormal situation is the occurrence of traffic accidents and vehicle failures. The emergency call unit 112 initiates a connection with an operator when a predetermined trigger such as, for example, pressing down a call button provided in a vehicle or deployment of an airbag occurs, and enables a call between an occupant of the vehicle and the operator. Incidentally, at the time of the emergency call, the emergency call unit 112 may transmit a position information of the vehicle to the operator. In this case, the emergency-notification unit 112 may acquire the position information from GPS module 26.

A security management unit 113 performs a security monitoring process. For example, based on the data received from the ECU having jurisdiction over the electronic lock of the vehicle, the security management unit 113 detects that the vehicle is unlocked without using a normal procedure, and transmits a security notification to a predetermined device. The security notification may include the position information of the vehicle. In this case, the security manager 113 may acquire the position information from GPS module 26. When the security management unit 113 determines that a problem has occurred in the security of the vehicle, the security management unit 113 may acquire the position information and periodically transmit the acquired position information to an external device designated in advance.

Next, the in-vehicle device 20 will be described.

The in-vehicle device 20 is a device that provides information to an occupant of the vehicle.

The control device 21 is an arithmetic unit that realizes various functions of the in-vehicle device 20 by executing a predetermined program.

The control device 21 is configured to be capable of providing the following functions, for example.
Navigation Function: A function of searching a traveling route of a vehicle and guiding the vehicle to an occupant.
Terminal link function: A function of connecting to a terminal (smartphone or the like) possessed by an occupant of a vehicle, and playing music or video, mirroring a screen, and the like.
Audio: The ability to play songs stored on a storage device.
Television/Radio Function: The function to receive radio broadcasting and digital television broadcasting.
These functions can be provided, for example, via an input/output unit 23 (for example, a touch panel display) which will be described later.

The storage device 22 is a memory device including a main storage device and an auxiliary storage device. The secondary storage device stores an operating system (OS), various programs, various tables, and the like. By loading the program stored therein into the main storage device and executing the program, it is possible to realize each function that matches a predetermined purpose, as will be described later.

The input/output unit 23 is a unit that receives an input operation performed by the user and presents information to the user. Specifically, the input/output unit 23 includes a touch panel, a control unit for the touch panel, a liquid crystal display, and a control unit for the liquid crystal display. The touch panel and the liquid crystal display are composed of one touch panel display in the present embodiment. The input/output unit 23 may include a unit (amplifier or speaker) for outputting sound, a unit (microphone) for inputting sound, and the like.

The broadcast receiving antenna 24 is an antenna element that receives radio waves of television broadcasting and radio broadcasting. The broadcast receiving antenna 24 may include a plurality of physical antennas. For example, a plurality of antennas oriented in different directions may be used as the broadcast receiving antenna 24.

The broadcast receiving antenna 24 may be built in the in-vehicle device 20 or may be external to the in-vehicle device 20. In this case, the broadcast receiving antenna 24 may be connected to the in-vehicle device 20 via a cable or the like.

The broadcast receiving module 25 is a module for receiving television broadcasting and radio broadcasting.

Like DCM 10, the in-vehicle device 20 can be configured as a computer including a processor such as a CPU or a GPU, a main storage device such as a RAM or a ROM, and an auxiliary storage device such as an EPROM, a disk drive, or a removable medium.

DCM 10 and the in-vehicle device 20 have an interface unit for connecting to an in-vehicle network.

Further, in the present embodiment, a plurality of vehicle components including DCM 10 and the in-vehicle device 20 are connected to each other via the network bus 30. As a standard of the in-vehicle networking, for example, CAN (Controller Area Network) can be exemplified. In the case where the in-vehicle network uses a plurality of standards, the communication interface may include a plurality of interface devices corresponding to the standards of the communication destination. As a communication standard other than the CAN, for example, Ethernet (registered trademark) can be shown as an example.

The network bus 30 is a communication bus constituting an in-vehicle network. Although one bus is illustrated in the present example, the vehicle 1 may have two or more communication buses. The plurality of communication buses may be connected to each other by a DCM 10 or a gateway that organizes the plurality of communication buses.

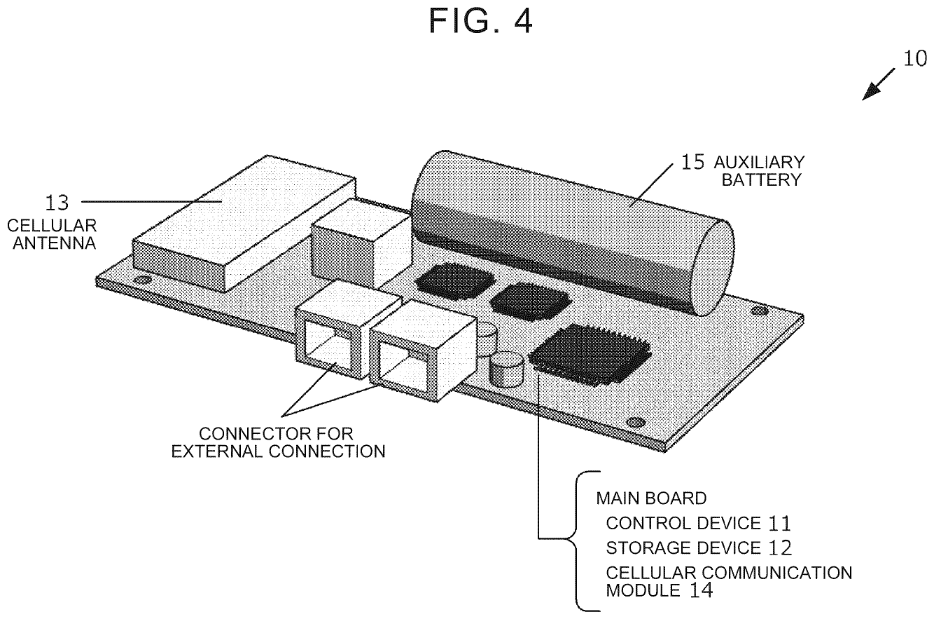

FIG. 4 is a view showing an external view of the hardware of DCM 10.

DCM 10 hardware includes a main board (base board) and various components mounted on the main board.

The main board is a board on which the control device 11, the storage device 12, the cellular antenna 13, the cellular communication module 14, and the auxiliary battery 15 are mounted. Although the cellular antenna 13 is mounted on the main board in the present example, the cellular antenna 13 may be connected to the main board via an external port.

DCM 10 may include a plurality of connectors for external connection. One of the plurality of connectors corresponds to an in-vehicle network bus such as CAN or Ethernet. The other connector may be an expansion connector. As such, for example, a port for connecting an external antenna to a DCM 10, a USB port for connecting an external device (for example, a maintenance-use terminal) to a DCM 10, and the like can be exemplified.

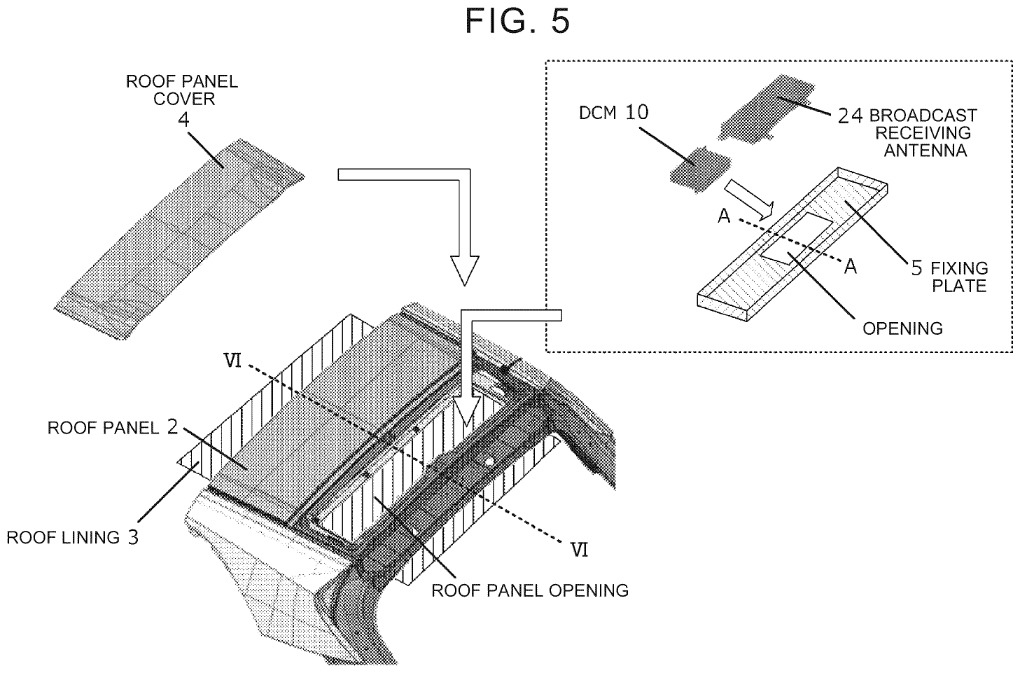

The illustrated hardware is disposed inside a roof of the vehicle 1. FIG. 5 is a diagram for explaining the incorporation of DCM 10 shown in FIG. 4 into the vehicles 1.

As illustrated, the roof panel 2 of the vehicle 1 is provided with an opening. A roof lining 3 (interior material) is arranged at the bottom of the opening.

DCM 10 is first attached to the fixation plate 5. In the present embodiment, the fixing plate 5 is a metal plate (conductor). The fixing plate 5 has a fastening portion (for example, a screw hole) for connecting to the main board of DCM 10, and is fastened to the main board by the fastening portion. Further, the fixed plate 5 is provided with an opening having a predetermined size, and a DCM 10 is mounted so as to straddle the opening (described later).

Components other than DCM 10 may be attached to the fixing plate 5. For example, the in-vehicle device 20, the broadcast receiving antenna 24 connected to the in-vehicle device 20, and the like may be fastened to the fixed plate 5. In the illustrated embodiment, the broadcast-receiving-antenna 24 is fastened together with DCM 10 to the fixed-plate 5.

The fixing plate 5 to which DCM 10 and the broadcasting receiving antenna 24 are attached is inserted from an opening provided in the roof panel 2, and is fixed to a space (hereinafter referred to as a storage space) between the roof panel 2 and the roof lining 3. The fixing plate 5 may be fixed to the roof panel 2 via a conductive member such as a screw. Thus, the fixed plate 5 can be grounded.

Finally, the roof panel cover 4 closes the opening of the roof panel. The roof panel cover 4 is made of a non-conductive material (e.g., resin).

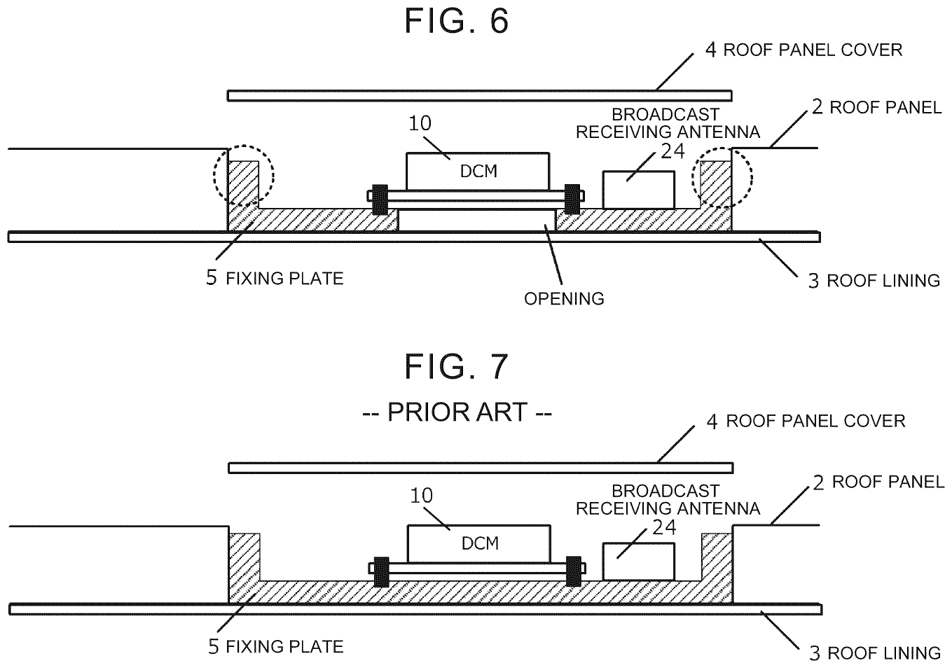

Next, a detailed shape of the fixing plate 5 will be described with reference to FIG. 6. FIG. 6 is a cross-sectional view (VI-VI cross-sectional view) of the fixed plate 5 attached to the vehicle 1.

As shown in FIG. 5, the fixing plate 5 has an opening, and DCM 10 is mounted so as to straddle the opening. When DCM 10 is connected to the fixing plate 5 by a plurality of screws, the length of one side of the opening is designed to be shorter than the distance between the screws.

The fixing plate 5 is in contact with the roof lining 3, that is, a surface located at the bottom of the storage space, and four vertically rising surfaces (“rising portions” in the present disclosure). It consists of the dotted lines in FIG. 6). The four sides of the storage space are surrounded by the rising portion.

In the past, it has been known to dispose DCM 10 and broadcasting receiving antennae 24 in a storage space surrounded by a roof panel and a roof lining. In this configuration, the cross-sectional view becomes as shown in FIG. 7.

However, in this case, five surfaces of the six surfaces forming the storage space are surrounded by a conductor, and thus cavity resonance may be generated due to electromagnetic waves generated inside and outside the storage space. The resonance frequency may vary depending on the storage space, the size of the fixed plate, and the like, but if the resonance frequency is close to the frequency used by DCM 10 for communication, the communication may be hindered. Further, since the base substrate and the fixed plate (i.e., the conductor) of the communication module is close to each other, a high-frequency current having a reverse phase is generated between the base substrate and the fixed plate, which may be noise, and may similarly hinder communication.

On the other hand, in the present embodiment, as shown in FIG. 6, an opening is provided in the fixing plate 5, and DCM 10 is arranged in a shape straddling the opening. According to this configuration, since the base substrate and the fixed plate can be separated from each other, generation of an anti-phase current can be suppressed. That is, the antenna performance can be improved. Further, by adjusting the size of the opening, the frequency of the transmitted electromagnetic wave can be controlled, so that resonance occurring in the storage space can be suppressed.

For example, it is known that when the long side of the storage space is less than 2 meters, the resonant frequency becomes a UHF band (around 1 GHz). The spectrum may affect cellular communications and GNSS signaling. In addition, when higher-order resonances occur in a SHF band (e.g., several GHz), communication such as Wi-Fi may be affected. Therefore, in order to suppress these resonances, the size of the opening portion may be adjusted so that the electromagnetic waves in the frequency band are transmitted from the inside to the outside of the storage space.

When the maximum length of the opening (for example, the length of the diagonal line) is X, the upper limit wavelength λ of the radio wave transmitted through the opening is represented by X=λ/2 according to the operation principle of the slot antenna. Here, for example, when the frequency (resonance frequency) of the noises is 1150 MHz, the wavelength thereof is 260 mm, and therefore, when the maximum length of the opening portion is equal to or larger than 130 mm, the electromagnetic wave of the frequency can be transmitted and the resonance can be reduced.

### Modified Examples

The above-described embodiments are merely examples, and the present disclosure may be appropriately modified and implemented without departing from the scope thereof.

For example, in the embodiment, the antenna for cellular communication (the first antenna) and the antenna for broadcast reception (the second antenna) are arranged in the storage space, but the second antenna is not limited to the antenna for broadcast reception.

Further, an antenna or the like that receives a positioning signal transmitted from a positioning satellite (also referred to as a GNSS satellite) may be further arranged in the storage space. The antenna is also an example of a second antenna. Since the resonance can be reduced by providing the opening in the fixed plate, the reception performance of these antennas can also be improved.

Further, the vehicle 1 may be equipped with another vehicle located in the vicinity of the vehicle 1 or a terminal (V2X terminal) that communicates with the roadside device. V2X terminal performs communication using a centimeter wave or a millimeter wave.

As a function provided by V2X terminal, for example, a function of suppressing collisions between vehicles by exchanging data with other vehicles by inter-vehicle communication, a function of acquiring data related to a traffic signal by road-to-vehicle communication, and the like are exemplified. Note that a V2X function may be provided as a part of the autonomous driving function.

V2X terminal generates a specified message, and executes a function of periodically broadcasting the message to the outside of the vehicle, a function of acquiring a message transmitted by another V2X terminal, and a function of controlling the traveling of the host vehicle based on the message.

In this case, an antenna for performing V2X communication may be further arranged in the storage space.

Further, for example, in the explanation of the embodiment, the communication module and the antenna using the cellular communication are exemplified, but DCM 10 may be equipped with a plurality of communication modules and a plurality of sets of antennas corresponding to other communication standards. Examples of such a communication method include Wi-Fi (registered trademark) and Bluetooth (registered trademark).

What is claimed is:

1. A vehicle roof structure, in which a space in which a communication module having a first antenna and a base substrate and a second antenna are disposed is formed between a roof panel and a roof lining, wherein:
a roof panel cover of a non-conductive material is disposed above the space;
a conductor plate to which the communication module and the second antenna are attachable is disposed below the space; and
an opening is provided in at least a part of a portion of the conductor plate facing the base substrate.

2. The vehicle roof structure according to claim 1, wherein the conductor plate has a rising portion that surrounds a side of the space.

3. The vehicle roof structure according to claim 1, wherein the first antenna is an antenna for cellular communication.

4. The vehicle roof structure according to claim 1, wherein the second antenna is an antenna for broadcast reception.

5. A conductor plate disposed between a roof panel and a roof lining of a vehicle, a communication module having a first antenna and a base substrate and a second antenna being attachable to the conductor plate, wherein an opening is provided in at least a part of a portion of the conductor plate facing the base substrate.
